(19) United States
(12) Patent Application Publication
(10) Pub. No.: US 2025/0368217 A1
(43) Pub. Date: Dec. 4, 2025

(54) AUTONOMOUS VEHICLE, CONTROL METHOD, AND SYSTEM FOR COLD START SAFETY MEASURES

(71) Applicant: AutoX, Inc., Grand Cayman (KY)

(72) Inventor: Jianxiong Xiao, Shenzhen (CN)

(73) Assignee: AutoX, Inc., Grand Cayman (KY)

(21) Appl. No.: 19/220,458

(22) Filed: May 28, 2025

(30) Foreign Application Priority Data
May 28, 2024 (CN) 2024106746264

(51) Int. Cl. B60W 50/14; B60W 60/00

(52) U.S. Cl. CPC B60W 50/14; B60W 60/00; B60W 2050/143; B60W 2420/408; B60W 2556/35

(57) ABSTRACT

The disclosure provides a control method for cold start safety measures of an autonomous vehicle. The control method for cold start safety measures includes steps of: controlling the cold start sensing system to collect environmental data, when the autonomous vehicle is in a cold start phase; identifying whether a risk exists for the autonomous vehicle based on the environmental data; and controlling an alarm device installed on the autonomous vehicle to emit an alarm when a risk exists for the autonomous vehicle.

### CROSS REFERENCE TO RELATED APPLICATION

This non-provisional patent application claims priority under 35 U. S. C. § 119 from Chinese Patent Application No. 202410674626.4 filed on May 28, 2024, the entire content of which is incorporated herein by reference.

### TECHNICAL FIELD

The disclosure relates to the field of autonomous driving technology, particularly to control methods, apparatuses, and sensors for cold start safety measures.

### BACKGROUND

After parking, existing autonomous vehicles typically shut down, including the autonomous vehicle's onboard system and autonomous driving system, and may enter a “sleep state.” After shutdown, the autonomous vehicle is unable to detect its surroundings. If it directly enters autonomous driving operation mode after a blind cold start, there are potential safety hazards.

### SUMMARY

The disclosure provides a control method for cold start safety measures of an autonomous vehicle. By controlling a cold start sensing system to collect environmental data of the autonomous vehicle during the cold start phase and controlling an alarm device to emit an alarm, the safety issues during cold start are ensured.

In a first aspect, the disclosure provides a control method for cold start safety measures of an autonomous vehicle. The method includes steps of controlling the cold start sensing system to collect environmental data, when the autonomous vehicle is in a cold start phase; identifying whether a risk exists for the autonomous vehicle based on the environmental data; and controlling an alarm device installed on the autonomous vehicle to emit an alarm when a risk exists for the autonomous vehicle.

In a second aspect, the disclosure provides a control system for cold start safety measures, including: a cold start sensing system, configured to collect environmental data; an alarm device, configured to emit an alarm; a controller, configured to: control the cold start sensing system to collect environmental data, when the autonomous vehicle is in a cold start phase; identify whether a risk exists for the autonomous vehicle based on the environmental data; and control an alarm device installed on the autonomous vehicle to emit an alarm when a risk exists for the autonomous vehicle.

In a third aspect, the disclosure provides an autonomous vehicle. The autonomous vehicle includes a cold start sensing system, configured to collecting environmental data; an alarm device, configured to emitg an alarm; and a controller, including: a memory, configured to store program instructions; a processor, configured to execute the program instructions to perform a control method for cold start safety measures of an autonomous vehicle, the control method for cold start safety measures of an autonomous vehicle includes steps of: controlling the cold start sensing system to collect environmental data, when the autonomous vehicle is in a cold start phase; identifying whether a risk exists for the autonomous vehicle based on the environmental data; and controlling an alarm device installed on the autonomous vehicle to emit an alarm when a risk exists for the autonomous vehicle.

The control method for cold start safety measures of the autonomous vehicle, when a risk exists around the autonomous vehicle during the cold start phase, causes the alarm device to emit vibrations and sounds at a special frequency to warn and startle people and animals that may be hiding around the autonomous vehicle. If, when the cold start phase of the autonomous vehicle ends, risks around the autonomous vehicle are not eliminated, the autonomous vehicle enters a standby state to address the safety issues during the cold start phase.

### BRIEF DESCRIPTION OF THE DRAWINGS

To more clearly illustrate the technical solutions in the embodiments of the disclosure or in the prior art, the drawings required for the description of the embodiments or the prior art will be briefly introduced below. It is obvious that the drawings in the following description are only some embodiments of the disclosure. For those of ordinary skill in the art, other drawings can be obtained based on these drawings without creative efforts.

FIG. 1 is a flowchart of a control method for cold start safety measures of an autonomous vehicle in according to an embodiment.

FIG. 2 is a scenario diagram of a control method for cold start safety measures of an autonomous vehicle in according to an embodiment.

FIG. 3 is a structural block diagram of a control system for cold start safety measures of an autonomous vehicle in according to an embodiment.

FIG. 4 is a sub-structural block diagram of a control system in according to an embodiment.

FIG. 5 is a structural diagram of cold start safety measures for an autonomous vehicle in according to a second embodiment.

### DETAILED DESCRIPTION OF THE EMBODIMENTS

In order to make the purpose, technical solution, and advantages of disclosure clearer and clearer, the following will provide further detailed explanations of disclosure in conjunction with the accompanying drawings and embodiments. It should be understood that the specific embodiments described here are only intended to explain the present application and are not intended to limit the present application. Based on the embodiments in disclosure, all other embodiments obtained by ordinary technical personnel in this field without creative labor fall within the scope of protection of disclosure.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is understood that the descriptions involving “first,” “second,” etc., in the present application are solely for descriptive purpos and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

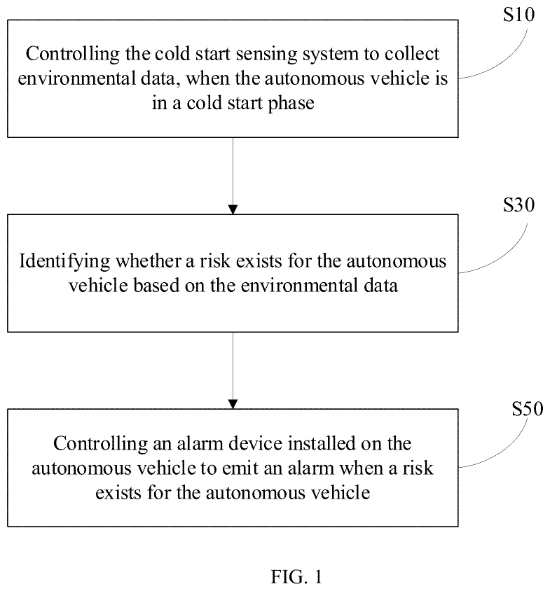

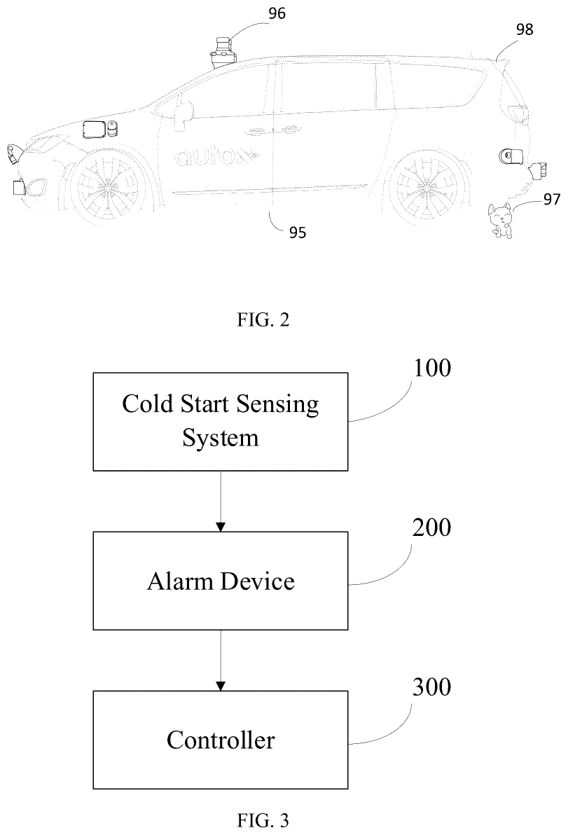

Referring to FIGS. 1-2, FIG. 1 is a flowchart of a control method for cold start safety measures of an autonomous vehicle 98. FIG. 2 is a schematic diagram of an application scenario for the control method for cold start safety measures of an autonomous vehicle 98 provided by an embodiment. This application scenario may involve an autonomous vehicle 98 performing cold start safety measures while parked. The control method for cold start safety measures of the autonomous vehicle 98 is applied to the autonomous vehicle 98. The control method for cold start safety measures of the autonomous vehicle 98 includes the following steps.

Step S10: when the autonomous vehicle 98 is in a cold start phase, controlling the cold start sensing system 100 to collect environmental data around the autonomous vehicle 98. The cold start sensing system 100 further includes a fusion sensor 96 arranged at the top, which will be described in detail below and will not be elaborated on here. Specifically, the sensing control module 301 in the controller 300 controls the cold start sensing system 100 to activate several sensors of the autonomous vehicle 98 to acquire environmental data around the autonomous vehicle 98 during the cold start phase. The field of view angles of these sensors cover the underbody area, the roof area, and the surrounding area of the autonomous vehicle body of the autonomous vehicle 98. In this embodiment, the sensing control module 301 controls the concealed sensor 95 at the bottom of the autonomous vehicle 98 to extend out from the bottom of the autonomous vehicle body and controls the short-range LiDAR emitter in the sensor 96 at the top of the autonomous vehicle 98 to emit a laser beam while controlling the long-range and/or medium-range LiDAR emitters to stop emitting laser beams, thereby collecting environmental data around the autonomous vehicle 98. The sensor 95 at the bottom of the autonomous vehicle 98 can be any type of Camera, LiDAR, etc. The long-range, medium-range, and short-range LiDAR emitters emit laser beams at different distances, respectively. Compared to ordinary autonomous vehicles, this setup can not only collect environmental data from the surrounding area but also obtain environmental data from the underbody and roof areas.

Step S30: Identifying whether a risk exists around the autonomous vehicle 98 during cold start, based on the environmental data. Specifically, the identification module 302 in the controller 300 identifies whether a risk exists in the environmental data. In this embodiment, a neural network can first be trained using sample images of obstacles 97. After training is completed, the trained neural network is configured to recognize images, thereby improving the efficiency of image recognition. The obstacles 97 can be animals, humans, or objects and can be located around the autonomous vehicle 98, including the surrounding area of the autonomous vehicle body, the underbody area, and the roof area.

Step S50: controlling the alarm device 200 installed on the autonomous vehicle 98 to emit an alarm when a risk exists around the autonomous vehicle 98. Specifically, the autonomous vehicle 98 identifies whether the obstacle 97 is living or non-living (e.g., an object) by emitting waves. If the obstacle 97 is living, it further distinguishes whether the obstacle 97 is a human or an animal using a camera. If the obstacle 97 is an animal, the autonomous vehicle 98 emits a vibration with a preset duration of 1 minute and a frequency of 40 Hz through a vibration motor in the alarm device 200 and a wave of a specific frequency with a preset duration of 1 minute through a sound wave generator. If the obstacle 97 is a human, the autonomous vehicle 98 flashes lights and emits a 1-minute alarm sound through the alarm device 200. If the obstacle 97 is non-living, the alarm device emits a 1-minute alarm to remind the user to remove the obstacle 97.

In some embodiments, during the cold start phase of the autonomous vehicle 98, the identification module 302 in the controller 300 identifies a risk based on the environmental data, and the alarm control module 303 in the controller 300 controls the alarm device 200 to emit an alarm. the autonomous vehicle 98 identifies whether the obstacle 97 is living by emitting waves and further activates the camera to distinguish whether the obstacle 97 is an animal. The autonomous vehicle 98 emits a vibration with a preset duration of 1 minute and a frequency of 40 Hz through a vibration motor in the alarm device 200 and a wave of a specific frequency with a preset duration of 1 minute through a sound wave generator.

In some embodiments, during the cold start phase of the autonomous vehicle 98, the identification module 302 in the controller 300 identifies a risk based on the environmental data, and the alarm control module 303 in the controller 300 controls the alarm device 200 to emit an alarm. the autonomous vehicle 98 identifies whether the obstacle 97 is living by emitting waves and, if located at the bottom of the autonomous vehicle 98, defaults the obstacle 97 to be an animal. The autonomous vehicle 98 emits a vibration with a preset duration of 1 minute and a frequency of 40 Hz through a vibration motor in the alarm device 200 and a wave of a specific frequency with a preset duration of 1 minute through a sound wave generator.

In some embodiments, during the cold start phase of the autonomous vehicle 98, the identification module 302 in the controller 300 identifies a risk based on the environmental data, and the alarm control module 303 in the controller 300 controls the alarm device 200 to emit an alarm. the autonomous vehicle 98 identifies whether the obstacle 97 is living by emitting waves and further activates the camera to distinguish whether the obstacle 97 is a human. The autonomous vehicle 98 flashes lights and emits a 1-minute alarm sound through the alarm device 200.

In some embodiments, during the cold start phase of the autonomous vehicle 98, the identification module 302 in the controller 300 identifies a risk based on the environmental data, and the alarm control module 303 in the controller 300 controls the alarm device 200 to emit an alarm. the autonomous vehicle 98 identifies whether the obstacle 97 is non-living by emitting waves, and the alarm device emits a 1-minute alarm to remind the user to remove the obstacle 97.

In some embodiments, if no risk is detected around the autonomous vehicle 98 during the cold start phase, the sensing control module 301 in the controller 300 controls the cold start sensing system 100 to extend the concealed sensor 95 from the bottom of the autonomous vehicle and controls the short-range LiDAR emitter in the sensor 96 at the top of the autonomous vehicle 98 to emit a laser beam while controlling the long-range and/or medium-range LiDAR emitters to stop emitting laser beams, thereby collecting environmental data around the autonomous vehicle 98. When the cold start phase ends and no risk is still detected around the autonomous vehicle 98, the sensing control module 301 in the controller 300 controls the cold start sensing system 100 to retract the concealed sensor 95 under the autonomous vehicle, stops collecting the environmental data, and controls the short-range LiDAR emitter in the sensor 96 at the top of the autonomous vehicle 98 to stop emitting a laser beam while controlling the long-range and/or medium-range LiDAR emitters to emit laser beams, thereby collecting environmental data at medium and long distances around the autonomous vehicle 98.

In some embodiments, if a risk is detected around the autonomous vehicle 98 during the cold start phase, the alarm control module 303 in the controller 300 controls the alarm device 200 to emit an alarm. the autonomous vehicle 98 identifies whether the obstacle 97 is living or non-living by emitting waves. If the obstacle 97 is living, it further distinguishes whether the obstacle 97 is a human or an animal using a camera. If the obstacle 97 is an animal, the autonomous vehicle 98 emits a vibration with a preset duration of 1 minute and a frequency of 40 Hz through a vibration motor in the alarm device 200 and a wave of a specific frequency with a preset duration of 1 minute through a sound wave generator. If the obstacle 97 is a human, the autonomous vehicle 98 flashes lights and emits a 1-minute alarm sound through the alarm device 200. If the obstacle 97 is non-living, the alarm device emits a 1-minute alarm to remind the user to remove the obstacle 97. If the obstacle 97 moves away from the autonomous vehicle 98 and no risk is detected around the autonomous vehicle 98 when the cold start phase ends, the sensing control module 301 in the controller 300 controls the cold start sensing system 100 to retract the concealed sensor 95 under the autonomous vehicle, controls the short-range LiDAR emitter in the sensor 96 at the top of the autonomous vehicle 98 to stop emitting a laser beam, and controls the long-range and/or medium-range LiDAR emitters to emit laser beams, thereby collecting environmental data at medium and long distances around the autonomous vehicle 98. Additionally, if the autonomous vehicle 98 encounters any situations such as underbody collisions or malfunctions during autonomous driving, the sensing control module 301 in the controller 300 controls the cold start sensing system 100 to extend the concealed sensor 95 from the bottom of the autonomous vehicle to collect environmental data in the underbody area of the autonomous vehicle 98.

In some embodiments, the preset duration for the cold start phase is 2 minutes. If a risk is detected around the autonomous vehicle 98 during the cold start phase, the alarm control module 303 in the controller 300 controls the alarm device 200 to emit an alarm. the autonomous vehicle 98 identifies whether the obstacle 97 is living or non-living by emitting waves. If the obstacle 97 is living, it further distinguishes whether the obstacle 97 is a human or an animal using a camera. If the obstacle 97 is an animal, the autonomous vehicle 98 emits a vibration with a preset duration of 1 minute and a frequency of 40 Hz through a vibration motor in the alarm device 200 and a wave of a specific frequency with a preset duration of 1 minute through a sound wave generator. If the obstacle 97 is a human, the autonomous vehicle 98 flashes lights and emits a 1-minute alarm sound through the alarm device 200. If the obstacle 97 is non-living, the alarm device emits a 1-minute alarm to remind the user to remove the obstacle 97. If the obstacle 97 does not move away from the autonomous vehicle 98, the alarm control module 303 in the controller 300 re-controls the alarm device 200 to emit an alarm. If the obstacle 97 still does not move away from the autonomous vehicle 98 within the preset 2-minute duration of the cold start phase, the controller 300 controls the autonomous vehicle 98 to enter a standby state.

The preset durations for the cold start phase, alarm duration, and frequency mentioned in the above embodiments can be set according to actual calculation accuracy requirements. The values of 2 minutes, 1 minute, and 40 Hz provided above are merely examples. The alarm device 200 includes but is not limited to a vibration motor, a sound wave generator, and a speaker.

Referring to FIG. 3, FIG. 3 shows a control system for an autonomous vehicle 98 provided by a second aspect of the disclosure. The control system includes a cold start sensing system 100, an alarm device 200, and a controller 300.

The cold start sensing system 100 is configured to collect environmental data of the autonomous vehicle 98 and includes several sensors arranged on the autonomous vehicle 98, including a concealed sensor 95 at the bottom of the autonomous vehicle 98 and a fusion sensor 96 at the top of the autonomous vehicle 98. For the concealed sensor 95 at the bottom of the autonomous vehicle 98, controlling the cold start sensing system 100 to collect environmental data specifically includes: when the autonomous vehicle is in a cold start phase, controlling the concealed sensor to extend out from the bottom of the autonomous vehicle to collect the environmental data; and when the cold start phase of the autonomous vehicle ends, controlling the concealed sensor to retract and be concealed at the bottom of the autonomous vehicle and stop collecting the environmental data. The fusion sensor 96 includes at least one of a long-range LiDAR emitter, a medium-range LiDAR emitter, a short-range LiDAR emitter, and a LiDAR receiver. The long-range, medium-range, and short-range LiDAR emitters emit laser beams at different distances, respectively. The LiDAR receiver is configured to receive at least one type of laser beam reflected back from the long-range, medium-range, and short-range LiDAR emitters. When the autonomous vehicle is in a cold start phase, the sensing control module is configured to control the short-range LiDAR emitter to emit a laser beam and control the long-range and/or medium-range LiDAR emitters to stop emitting laser beams. When the cold start phase of the autonomous vehicle ends, the sensing control module 100 is further used to control the short-range LiDAR emitter to stop emitting a laser beam and control the long-range and/or medium-range LiDAR emitters to emit laser beams.

The alarm device 200 includes a vibration motor, a sound wave generator, a speaker, etc., and is configured to emit an alarm.

The controller 300 is configured to control the cold start sensing system 100 and the alarm device 200 and will be described in detail below.

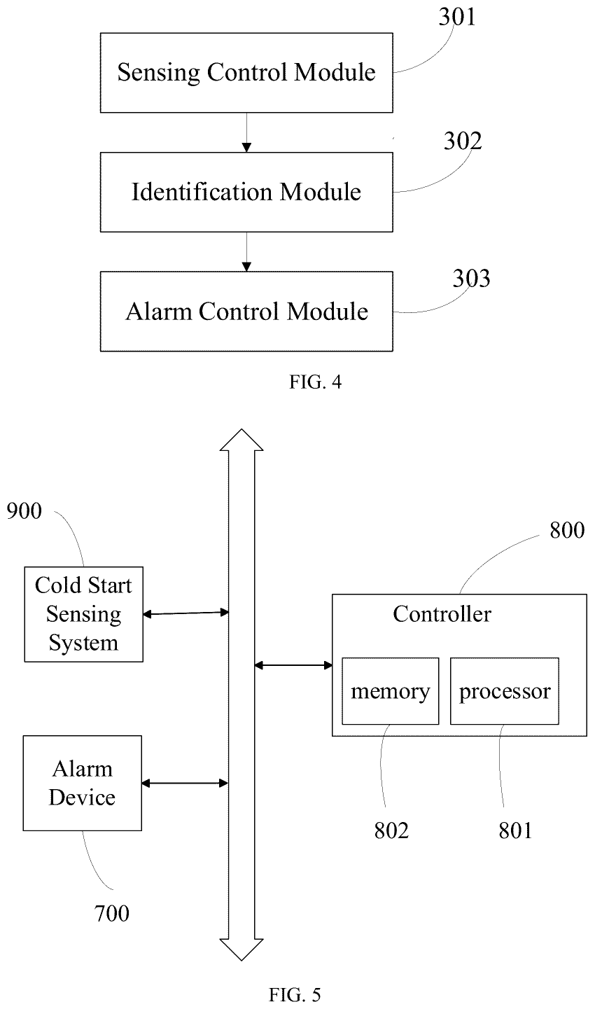

Referring to FIG. 4, FIG. 4 shows a sub-structural block diagram of the control system 300 of the disclosure. The sub-structural block diagram includes a sensing control module 301, an identification module 302, and an alarm control module 303.

The sensing control module 301 is configured to control the cold start sensing system 100 to collect environmental data when the autonomous vehicle 98 is in a cold start phase.

The identification module 302 is configured to identify whether a risk exists around the autonomous vehicle when the autonomous vehicle 98 is in a cold start phase.

The alarm control module 303 is configured to control the alarm device 200 to emit an alarm when a risk exists around the autonomous vehicle during the cold start phase of the autonomous vehicle 98.

A third aspect of the disclosure provides an autonomous vehicle 98. Referring to FIG. 5, the autonomous vehicle 98 includes a cold start sensing system 900, an alarm device 700, and a controller 800. The controller 800 includes a processor 801 and a memory 802. The memory 801 is configured to store control program instructions for the autonomous vehicle 98, and the processor 802 is configured to execute the control program instructions for the autonomous vehicle 98 to implement the control method for the autonomous vehicle 98.

The processor 801 can be, in some embodiments, a Central Processing Unit (CPU), microcontroller, microprocessor, or other data processing chip used to run the control program instructions for the intelligent sweeping robot 98 stored in the memory 802.

The memory 802 includes at least one type of readable storage medium, which includes a flash memory, hard disk, multimedia card, card-type memory (e.g., SD or DX memory, etc.), magnetic memory, magnetic disk, optical disc, etc. In some embodiments, the memory 802 can be an internal storage unit of a computer device, such as a hard disk of the computer device. In other embodiments, the memory 802 can also be an external storage device of a computer device, such as a plug-in hard disk configured in the computer device, a Smart Media Card (SMC), a Secure Digital (SD) card, a Flash Card, etc. Furthermore, the memory 802 can include both internal storage units and external storage devices of the computer device. The memory 802 can not only be used to store application software and various data installed on the computer device, such as code for implementing intelligent lifting processing, but also be used to temporarily store data that has been output or is to be output.

In the above embodiments, all or part of the processes can be implemented through software, hardware, firmware, or any combination thereof. When implemented using software, all or part of the processes can be implemented in the form of a computer program product.

The computer program product includes one or more computer instructions. When loaded and executed on a computer, the computer program instructions generate, in whole or in part, processes or functions in accordance with the embodiments of the present application. The computer can be a general-purpose computer, a dedicated computer, a computer network, or other programmable devices. The computer instructions can be stored in a computer-readable storage medium or transmitted from one computer-readable storage medium to another, such as from a website, computer, server, or data center through wired (e.g., coaxial cable, fiber optic, Digital Subscriber Line (DSL)) or wireless (e.g., infrared, wireless, microwave, etc.) means to another website, computer, server, or data center. The computer-readable storage medium can be any available medium that can be accessed by a computer or a data storage device that integrates one or more available media, such as a server or a data center. The available medium can be a magnetic medium (e.g., floppy disk, hard disk, magnetic tape), an optical medium (e.g., DVD), or a semiconductor medium (e.g., Solid State Disk (SSD)), etc.

Those skilled in the art can clearly understand that, for the convenience and brevity of description, the specific working processes of the systems, devices, and units described above can refer to the corresponding processes in the method embodiments described above and will not be elaborated on here.

In the several embodiments provided by the present application, it should be understood that the disclosed systems, devices, and methods can be implemented in other ways. For example, the device embodiments described above are merely illustrative. For instance, the division of the units is only a logical functional division, and there can be other divisions in actual implementation. For example, multiple units or components can be combined or integrated into another system, or some features can be ignored or not executed. Additionally, the coupling or direct coupling or communication connection shown or discussed can be indirect coupling or communication connection through some interfaces, devices, or units, and can be in electrical, mechanical, or other forms.

The units described as separate components may or may not be physically separate, and the components displayed as units may or may not be physical units. That is, they can be located in one place or distributed over multiple network units. Some or all of the units can be selected according to actual needs to achieve the objectives of the solutions in the embodiments.

Furthermore, the functional units in the various embodiments of the present application can be integrated into one processing unit, or each unit can exist separately, or two or more units can be integrated into one unit. The integrated units can be implemented in hardware or as software functional units.

If the integrated unit is implemented as a software functional unit and sold or used as an independent product, it can be stored in a computer-readable storage medium. Based on such understanding, the technical solutions of the present application, or parts thereof that contribute to the existing technology or all or part of the technical solutions, can be embodied in the form of a software product stored in a storage medium. The software product includes several instructions that enable a computer device (which can be a personal computer, server, or network device, etc.) to execute all or part of the steps of the methods in the various embodiments of the present application. The aforementioned storage medium includes: U disk, mobile hard disk, Read-Only Memory (ROM), Random Access Memory (RAM), magnetic disk, optical disc, and other media that can store program code.

It should be noted that the sequence numbers of the embodiments of the present application are only for the convenience of description and do not imply the superiority or inferiority of the embodiments. The terms “include,” “comprise,” or any variations thereof are intended to cover non-exclusive inclusions so that a process, method, article, or device that includes a series of elements includes not only those elements but also other elements not explicitly listed or inherent to such a process, method, article, or device. Without further limitations, the element defined by the phrase “including a . . . ” does not exclude the presence of other identical elements in the process, method, article, or device that includes the element.

Obviously, those skilled in the art can make various modifications and variations to the present application without departing from the spirit and scope of the present application. In this case, if such modifications and variations of the present application fall within the scope of the claims and their equivalents, the present application is also intended to include these modifications and variations.

The above are merely preferred embodiments of the present application and are not intended to limit the protection scope of the present application. Any equivalent structural or equivalent process transformations made using the content of the specification and drawings of the present application or direct or indirect applications in other related technical fields are included in the protection scope of the present application.

1. A control method for cold start safety measures of an autonomous vehicle, the autonomous vehicle comprising a cold start sensing system, the control method for cold start safety measures comprising:
controlling the cold start sensing system to collect environmental data, when the autonomous vehicle is in a cold start phase;
identifying whether a risk exists for the autonomous vehicle based on the environmental data; and
controlling an alarm device installed on the autonomous vehicle to emit an alarm when a risk exists for the autonomous vehicle.

2. The control method for the cold start safety measures according to claim 1, further comprises:
controlling the cold start sensing system to stop working, when the autonomous vehicle does not have a risk within a predetermined time period.

3. The control method for cold start safety measures according to claim 2, wherein the cold start sensing system comprises a plurality of sensors arranged on the autonomous vehicle, and field of view angles of the plurality of sensors covering the underbody area, the roof area, and a surrounding area of a vehicle body of the autonomous vehicle.

4. The control method for the cold start safety measures according to claim 3,
wherein a concealed sensor is arranged at a bottom of the autonomous vehicle, controlling the cold start sensing system to collect environmental data comprising:
controlling the concealed sensor to extend out from the bottom of the autonomous vehicle to collect the environmental data, when the autonomous vehicle is in a cold start phase;
controlling the concealed sensor to retract and be concealed at the bottom of the autonomous vehicle and stopping collecting the environmental data, when the cold start phase of the autonomous vehicle ends.

5. The control method for cold start safety measures according to claim 3, wherein the cold start sensing system further includes a fusion sensor arranged at a top of the autonomous vehicle, the fusion sensor includes at least one of a long-range LiDAR emitter, a medium-range LiDAR emitter, a short-range LiDAR emitter, and a LiDAR receiver, the long-range LiDAR emitter, the medium-range LiDAR emitter, and the short-range LiDAR emitter emit laser beams at different distances, respectively; the LiDAR receiver is configured to receive at least one type of laser beam reflected back from the long-range LiDAR emitter, medium-range LiDAR emitter, and short-range LiDAR emitter, controlling the cold start sensing system to collect environmental data comprises:
when the autonomous vehicle is in the cold start phase, controlling the short-range LiDAR emitter to emit a laser beam and controlling the long-range emitter and/or medium-range LiDAR emitter to stop emitting laser beams;
when the cold start phase of the autonomous vehicle ends, controlling the short-range LiDAR emitter to stop emitting a laser beam, and controlling the long-range LiDAR emitter and/or medium-range LiDAR emitter to emit laser beams.

6. The control method for cold start safety measures according to claim 3, further comprising:
controlling the autonomous vehicle to enter a standby state, when the cold start phase of the autonomous vehicle ends and risks around the autonomous vehicle are not eliminated.

7. A control system for cold start safety measures, comprising:
a cold start sensing system, configured to collect environmental data;
an alarm device, configured to emit an alarm;
a controller, configured to:
control the cold start sensing system to collect environmental data, when the autonomous vehicle is in a cold start phase;
identify whether a risk exists for the autonomous vehicle based on the environmental data; and
control an alarm device installed on the autonomous vehicle to emit an alarm when a risk exists for the autonomous vehicle.

8. The control system for the cold start safety measures according to claim 7,
wherein the controller further is configured to:
control the cold start sensing system to stop working, when the autonomous vehicle does not have a risk within a predetermined time period.

9. The control system for the cold start safety measures according to claim 8,
wherein the cold start sensing system comprising a plurality of sensors arranged on the autonomous vehicle, and field of view angles of the plurality of sensors covering the underbody area, the roof area, and a surrounding area of a vehicle body of the autonomous vehicle.

10. The control system for the cold start safety measures according to claim 9,
wherein a concealed sensor is arranged at a bottom of the autonomous vehicle, control the cold start sensing system to collect environmental data comprising:
control the concealed sensor to extend out from the bottom of the autonomous vehicle to collect the environmental data, when the autonomous vehicle is in a cold start phase;
control the concealed sensor to retract and be concealed at the bottom of the autonomous vehicle and stopping collecting the environmental data, when the cold start phase of the autonomous vehicle ends.

11. The control system for cold start safety measures according to claim 3, wherein the cold start sensing system further includes a fusion sensor arranged at a top of the autonomous vehicle, the fusion sensor includes at least one of a long-range LiDAR emitter, a medium-range LiDAR emitter, a short-range LiDAR emitter, and a LiDAR receiver; the long-range LiDAR emitter, the medium-range LiDAR emitter, and the short-range LiDAR emitter emit laser beams at different distances, respectively; the LiDAR receiver is configured to receive at least one type of laser beam reflected back from the long-range LiDAR emitter, medium-range LiDAR emitter, and short-range LiDAR emitter, control the cold start sensing system to collect environmental data comprises:
when the autonomous vehicle is in the cold start phase, controlling the short-range LiDAR emitter to emit a laser beam and controlling the long-range emitter and/or medium-range LiDAR emitter to stop emitting laser beams;
when the cold start phase of the autonomous vehicle ends, controlling the short-range LiDAR emitter to stop emitting a laser beam, and controlling the long-range LiDAR emitter and/or medium-range LiDAR emitter to emit laser beams.

12. The control system for cold start safety measures according to claim 9, the controller is further configured to:
control the autonomous vehicle to enter a standby state, when the cold start phase of the autonomous vehicle ends and risks around the autonomous vehicle are not eliminated.

13. An autonomous vehicle, comprising:
a cold start sensing system, configured to collecting environmental data;
an alarm device, configured to emitg an alarm; and
a controller, comprising:
a memory, configured to store program instructions;
a processor, configured to execute the program instructions to perform a control method for cold start safety measures of an autonomous vehicle, the control method for cold start safety measures of an autonomous vehicle comprising:
controlling the cold start sensing system to collect environmental data, when the autonomous vehicle is in a cold start phase;
identifying whether a risk exists for the autonomous vehicle based on the environmental data; and
controlling an alarm device installed on the autonomous vehicle to emit an alarm when a risk exists for the autonomous vehicle.

14. The autonomous vehicle according to claim 13, wherein the control method for cold start safety measures of an autonomous vehicle further comprises:
controlling the cold start sensing system to stop working, when the autonomous vehicle does not have a risk within a predetermined time period.

15. The autonomous vehicle according to claim 14, wherein the cold start sensing system comprises a plurality of sensors arranged on the autonomous vehicle, and field of view angles of the plurality of sensors covering the underbody area, the roof area, and a surrounding area of a vehicle body of the autonomous vehicle.

16. The autonomous vehicle according to claim 15, wherein a concealed sensor is arranged at a bottom of the autonomous vehicle, controlling the cold start sensing system to collect environmental data comprising:
controlling the concealed sensor to extend out from the bottom of the autonomous vehicle to collect the environmental data, when the autonomous vehicle is in a cold start phase;
controlling the concealed sensor to retract and be concealed at the bottom of the autonomous vehicle and stopping collecting the environmental data, when the cold start phase of the autonomous vehicle ends.

17. The autonomous vehicle according to claim 15, wherein the cold start sensing system further includes a fusion sensor arranged at a top of the autonomous vehicle, the fusion sensor includes at least one of a long-range LiDAR emitter, a medium-range LiDAR emitter, a short-range LiDAR emitter, and a LiDAR receiver, the long-range LiDAR emitter, the medium-range LiDAR emitter, and the short-range LiDAR emitter emit laser beams at different distances, respectively; the LiDAR receiver is configured to receive at least one type of laser beam reflected back from the long-range LiDAR emitter, medium-range LiDAR emitter, and short-range LiDAR emitter, controlling the cold start sensing system to collect environmental data comprises:
when the autonomous vehicle is in the cold start phase, controlling the short-range LiDAR emitter to emit a laser beam and controlling the long-range emitter and/or medium-range LiDAR emitter to stop emitting laser beams;
controlling the short-range LiDAR emitter to stop emitting a laser beam, and controlling the long-range LiDAR emitter and/or medium-range LiDAR emitter to emit laser beams, when the cold start phase of the autonomous vehicle ends.

18. The autonomous vehicle according to claim 15, wherein the control method for cold start safety measures of an autonomous vehicle comprising:
controlling the autonomous vehicle to enter a standby state, when the cold start phase of the autonomous vehicle ends and risks around the autonomous vehicle are not eliminated.
